(19) United States
(12) Patent Application Publication
(10) Pub. No.: US 2016/0055777 A1
(43) Pub. Date: Feb. 25, 2016

(54) DISPLAY DEVICE AND METHOD OF DRIVING THE SAME

(71) Applicant: Samsung Display Co., Ltd., Yongin-City (KR)

(72) Inventor: Jung-Hak Kim, Hwaseong-si (KR)

(21) Appl. No.: 14/599,171

(22) Filed: Jan. 16, 2015

(30) Foreign Application Priority Data
Aug. 19, 2014 (KR) 10-2014-0107526

(51) Int. Cl. G09G 3/00; G09G 3/20; G09G 3/32

(52) U.S. Cl. CPC G09G 3/006; G09G 3/3275; G09G 3/3225; G09G 3/2092; G09G 2330/045; G09G 2310/08; G09G 2330/12

(57) ABSTRACT

A display device and a method of driving the same are disclosed. In one aspect, the display device includes a display panel including a plurality of pixels formed in a display area and a heat prevention circuit formed in a non-display area, wherein the heat prevention circuit is configured to selectively provide a data signal or a heat prevention voltage to a plurality of data lines. The display device further includes a data driver electrically connected to the data lines and configured to provide the data signal or the heat prevention voltage to the display panel, a scan driver configured to provide a scan signal to the display panel through a plurality of scan lines, and a timing controller configured to control the heat prevention circuit, the data driver, and the scan driver.

### CROSS-REFERENCE TO RELATED APPLICATION(S)

This application claims priority under 35 USC §119 to Korean Patent Applications No. 10-2014-0107526, filed on Aug. 19, 2014 in the Korean Intellectual Property Office (KIPO), the contents of which are incorporated herein in its entirety by reference.

### BACKGROUND

1. Field

The described technology generally relates to a display device and a method of driving the display device.

2. Description of the Related Technology

Flat panel displays (FPDs) are widely used in electronic devices because they are relatively lightweight and thin compared to cathode-ray tube (CRT) displays. Exemplary distinct uses of FPD technologies include liquid crystal displays (LCDs), field emission displays (FEDs), plasma display panels (PDPs) displays, and organic light-emitting diode (OLED) displays. OLED displays have been spotlighted as a next-generation display device because of their favorable characteristics such as a wide viewing angle, a rapid response speed, a thin profile, low power consumption, etc.

### SUMMARY OF CERTAIN INVENTIVE ASPECTS

One inventive aspect is a display device that can detect damage to a film in a data driving unit that is implemented by a chip on film and reducing flammability.

Another aspect is a method of driving a display device that can detect a damage of a film of a data driving unit that is implemented by a chip on film and decreasing a possibility of fire.

Another aspect is a display device that includes a display panel including a plurality of pixels formed in a display area and a heat prevention circuit formed in a non-display area, the heat prevention circuit selectively providing a data signal or a heat prevention voltage to a plurality of data lines, a data driving unit configured to provide the data signal or the heat prevention voltage to the display panel, a scan driving unit configured to provide a scan signal to the display panel through a plurality of scan lines, and a timing control unit configured to control the heat prevention circuit, the data driving unit, and the scan driving unit.

In example embodiments, the data driving unit is implemented by a chip on film (COF) that includes a data driving integrated circuit (IC) that converts an image signal output from the timing control unit into the data signal and a film on which the data driving integrated circuit is mounted.

In example embodiments, first and second sensing lines that sense whether the film is damaged are formed on the film.

In example embodiments, one ends of the first and second sensing lines are coupled to the display panel, and another ends of the first and second sensing lines are coupled to the data driving integrated circuit.

In example embodiments, the data driving integrated circuit generates a detecting signal indicating whether the film is damaged based on a sensing signal provided from the first and second sensing lines and provide the detecting signal to the timing control unit.

In example embodiments, one end of the first sensing line is coupled to the display panel, and another end of the first sensing line is coupled to the data driving integrated circuit, and one end of the second sensing line is coupled to the data driving integrated circuit, and another end of the second sensing line is coupled to the timing control unit.

In example embodiments, the data driving integrated circuit generates a detecting signal indicating whether the film is damaged based on a sensing signal provided from the first sensing line and provides the detecting signal to the timing control unit through the second sensing line.

In example embodiments, the timing control unit generates first and second driving control signals that control the heat prevention circuit based on a detecting signal indicating whether the film is damaged.

In example embodiments, the heat prevention circuit includes a first switching transistor configured to provide the data signal provided from the data driving integrated circuit to the data lines in response to the first driving control signal provided from the timing control unit, and a second switching transistor configured to provide the heat prevention voltage provided through the film to the data lines in response to the second driving control signal provided from the timing control unit.

In example embodiments, the first and second transistors are implemented as P-channel Metal Oxide Semiconductor (PMOS) transistors.

In example embodiments, when the film is damaged, the first driving control signal having a logic high level is provided to the first switching transistor, and the second driving control signal having a logic low level is provided to the second switching transistor.

In example embodiments, when the film is not damaged, the first driving control signal having a logic low level is provided to the first switching transistor, and the second driving control signal having a logic high level is provided to the second switching transistor.

In example embodiments, the first and second transistors are implemented as N-channel Metal Oxide Semiconductor (NMOS) transistors.

In example embodiments, when the film is damaged, the first driving control signal having a logic low level is provided to the first switching transistor, and the second driving control signal having a logic high level is provided to the second switching transistor.

In example embodiments, when the film is not damaged, the first driving control signal having a logic high level is provided to the first switching transistor, and the second driving control signal having a logic low level is provided to the second switching transistor.

In example embodiments, a black color image is displayed on a region of the display panel where the data lines are formed when the heat prevention voltage is provided to the data lines.

Another aspect is a method of driving a display device that includes a step of detecting whether a film of a data driving unit is damaged, the data driving unit being implemented by a chip on film (COF) that includes a data driving integrated circuit (IC) and the film on which the data driving integrated circuit is mounted and a step of selectively providing a data signal or a heat prevention voltage to a data line of a display panel based on whether the film is damaged

In example embodiments, the step of selectively providing the data signal or the heat prevention voltage includes a step of providing the data signal to the data line of the display panel when the film is not damaged, and a step of providing the heat prevention voltage to the data line of the display panel when the film is damaged.

In example embodiments, first and second sensing lines that senses whether the film is damaged are formed on the film, and the data driving integrated circuit generate a detecting signal indicating whether the film is damaged based on the sensing signal provided through the first and second sensing lines.

In example embodiments, a black color image is displayed on a region of the display panel where the data lines are formed when the heat prevention voltage is provided to the data lines.

Another aspect is a display device comprising a display panel including a plurality of pixels formed in a display area and a heat prevention circuit formed in a non-display area, wherein the heat prevention circuit is configured to selectively provide a data signal or a heat prevention voltage to a plurality of data lines. The display device further comprises a data driver electrically connected to the data lines and configured to provide the data signal or the heat prevention voltage to the display panel, a scan driver configured to provide a scan signal to the display panel through a plurality of scan lines, and a timing controller configured to control the heat prevention circuit, the data driver, and the scan driver.

In the above display device, the data driver is formed as a chip on film (COF) including i) a data driving integrated circuit (IC) configured to convert an image signal output from the timing controller into the data signal and ii) a film on which the data driving IC is mounted.

The above display device further comprises first and second sensing lines formed over the film and configured to sense whether the film is damaged.

In the above display device, first ends of the first and second sensing lines are electrically connected to the display panel, wherein second ends of the first and second sensing lines are electrically connected to the data driving IC.

In the above display device, the data driving IC is further configured to i) generate a detecting signal indicating whether the film is damaged based at least in part on a sensing signal provided from the first and second sensing lines and ii) provide the detecting signal to the timing controller.

In the above display device, a first end of the first sensing line is electrically connected to the display panel, wherein a second end of the first sensing line is electrically connected to the data driving integrated circuit, wherein a first end of the second sensing line is electrically connected to the data driving IC, and wherein a second end of the second sensing line is electrically connected to the timing controller.

In the above display device, the data driving IC is further configured to i) generate a detecting signal indicating whether the film is damaged based at least in part on a sensing signal provided from the first sensing line and ii) provide the detecting signal to the timing controller through the second sensing line.

In the above display device, the timing controller is further configured to generate first and second driving control signals configured to control the heat prevention circuit based at least in part on a detecting signal indicating whether the film is damaged, wherein the first driving control signal indicates that the film is not damaged, and wherein the second driving control signal indicates that the film is damaged.

In the above display device, the heat prevention circuit includes a first switching transistor configured to output the data signal based at least in part on the first driving control signal and a second switching transistor configured to output the heat prevention voltage to the data lines based at least in part on the second driving control signal.

In the above display device, each of the first and second transistors includes a p-channel metal oxide semiconductor (PMOS) transistor.

In the above display device, when the film is damaged, the first driving control signal has a logic high level and the second driving control signal has a logic low level.

In the above display device, when the film is not damaged, the first driving control signal has a logic low level, and the second driving control signal has a logic high level.

In the above display device, each of the first and second transistors includes a n-channel metal oxide semiconductor (NMOS) transistor.

In the above display device, when the film is damaged, the first driving control signal has a logic low level and the second driving control signal has a logic high level.

In the above display device, when the film is not damaged, the first driving control signal has a logic high level and the second driving control signal has a logic low level.

In the above display device, the display panel is configured to display a black color image on a region where the data lines are formed when the heat prevention voltage is provided to the data lines.

Another aspect is a method of driving a display device, the method comprising detecting whether a film of a data driver is damaged, wherein the data driver is formed as a chip on film (COF) including a data driving integrated circuit (IC) and a film on which the data driving IC is mounted. The method also comprises selectively providing a data signal or a heat prevention voltage to a data line of a display panel based at least in part on whether the film is damaged.

In the above method, the selectively providing includes providing the data signal to the data line when the film is not damaged and providing the heat prevention voltage to the data line when the film is damaged.

The above method further comprises forming first and second sensing lines configured to sense whether the film is damaged over the film and generating a detecting signal indicating whether the film is damaged based at least in part on the sensing signal received from the first and second sensing lines.

The above method further comprises displaying a black color image on a region of the display panel where the data lines are formed when the heat prevention voltage is provided to the data lines.

According to at least one of the disclosed embodiments, a display device and a method of driving the display device decrease a possibility of occurring fire by detecting a damage of a film of a data driving unit that is implemented by a chip on film and applying a heat prevention voltage to a data line coupled to the damaged film.

### BRIEF DESCRIPTION OF THE DRAWINGS

FIG. 1 is a block diagram illustrating a display device according to example embodiments.

FIG. 2 is a diagram illustrating the display device of FIG. 1.

FIGS. 3A and 3B are diagrams illustrating examples of a data driving unit included in the display device of FIG. 1.

FIGS. 4A through 4D are circuit diagrams illustrating a heat prevention circuit included in the display device of FIG. 1.

FIG. 5 is a block diagram illustrating an electronic device having the display device of FIG. 1.

FIG. 6 is a diagram illustrating an example in which the electronic device of FIG. 5 is implemented as a smart-phone.

FIG. 7 is a flowchart illustrating a method of driving a display device according to example embodiments.

FIG. 8 is a flowchart illustrating a method of providing data signal or heat prevention voltage by the method of FIG. 7.

FIGS. 9A and 9B are diagrams illustrating examples of an operating of a heat prevention circuit by the method of FIG. 7.

### DETAILED DESCRIPTION OF CERTAIN INVENTIVE EMBODIMENTS

Generally, OLED displays include a data driving unit that provides data signals and power signals to a display panel. The data driving unit can be implemented with a chip on film (COF) that includes a driving integrated circuit (IC) and a film on which the driving integrated circuit is mounted. When the film is damaged, the data signal and the power signal lines may short circuit. Furthermore, as the size of a display device increases, higher current is required. Thus, when the film is damaged, there is a potential for overheating and fire.

Hereinafter, the described technology will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

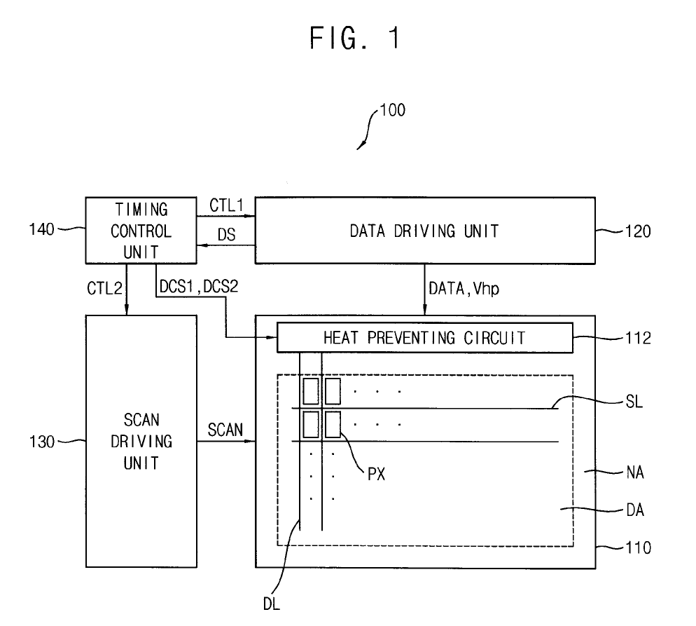

FIG. 1 is a block diagram illustrating a display device according to example embodiments.

Referring to FIG. 1, a display device 100 can include a display panel 110, a data driving unit or data driver 120, a scan driving unit or scan driver 130, and a timing control unit or timing controller 140.

The display panel 110 can include a display area DA and a non-display area NA. A plurality of pixels Px can be formed in the display area DA. The pixels Px can be formed in an intersection region of a plurality of data lines DL and a plurality of scan lines SL. Here, each pixel Px can include an organic light-emitting diode (OLED). In some embodiments, each pixel Px includes a pixel circuit, a driving transistor, and an OLED. In this case, the pixel circuit operates to provide a data signal, where the data signal is provided via data-lines DL, to the driving transistor based at least in part on a scan signal, where the scan signal is provided via scan-lines SL. The driving transistor can control a current flowing through the OLED based at least in part on the data signal DATA, and the OLED can emit light based at least in part on the current.

A heat prevention circuit 112 can be formed in the non-display area NA. The heat prevention circuit 112 can be formed at one end of the data lines DL. The heat prevention circuit 112 can selectively provide the data signal DATA or a heat prevention voltage Vhp from the data driving unit 120 to the data lines DL. For example, the heat prevention circuit 112 selectively transmits the data signal DATA or the heat prevention voltage Vhp provided from the data driving unit 120 based at least in part on a driving control signal DCS1 and DCS2 provided from the timing control unit 140. The heat prevention circuit 112 can be electrically connected to the data lines DL. The heat prevention circuit 112 can include a first switching transistor that transmits the data signal DATA provided from the data driving unit 120 to the data lines DL based at least in part on a first driving control signal DCS1 provided from the timing control unit 140 and a second switching transistor that transmits the heat prevention voltage Vhp provided from the data driving unit 120 to the data lines DL based at least in part on a second driving control signal DCS2 provided from the timing control unit 140. In some embodiments, the first and second transistors are implemented as p-channel metal oxide semiconductor (PMOS) transistors. In some embodiments, the first and second transistors are implemented as n-channel metal oxide semiconductor (NMOS) transistors.

The data driving unit 120 can provide the data signal DATA or the heat prevention voltage Vhp to the pixels Px through the plurality of data lines DL. The data driving unit 120 can be implemented with a chip on film (COF) that includes a data driving integrated circuit (IC) that converts an image signal output from the timing control unit 140 into the data signal DATA and a film on which the data driving integrated circuit is mounted. Sensing lines that sense whether the film is damaged can be formed on the film of the data driving unit 120. The data driving integrated circuit can generate a detecting signal DS indicating whether the film is damaged based at least in part on a sensing signal provided from the sensing lines and provide the detecting signal DS to the timing control unit 140. For example, when the sensing signal is higher or lower than a predetermined threshold value, the data driving integrated circuit determines that the film is damaged and output a logic low level voltage as the detecting signal DS. Further, when the sensing signal is within the predetermined threshold value or predetermined threshold range, the data driving integrated circuit can determine that the film is not damaged and output a logic high level voltage as the detecting signal DS.

The scan driving unit 130 can provide a scan signal SCAN to the pixels Px through the scan lines SL.

The timing control unit 130 can control the data driving unit 120 and the scan driving unit 130 by generating a plurality of control signals CTL1 and CTL2. Further, the timing control unit 140 can control an operation of the heat prevention circuit 112 by generating the first and second driving control signals DCS1 and DCS2 based at least in part on the detecting signal DS.

Generally, when the film of the data driving unit 120 is damaged, the data signal DATA can be abnormally applied to the data line DL of the display panel 110. Recently, the size of the display device 100 has been increasing, causing a current of the display panel 110 having a relatively high level to be required. Thus, when the film of the data driving unit 120 is damaged, a fire can occur due to heat of the film. The display device 100 according to some example embodiments form the heat prevention circuit 112 in the non-display area of the display panel 110 and provide the heat prevention voltage Vhp to the data line DL when the film of the data driving unit 120 is damaged. Here, the heat prevention voltage Vhp can have a voltage level to display a black color image on the display panel 110. As described, when the film of the data driving unit 120 is damaged, the heat prevention voltage Vhp that can display an image driven with a current having relatively low level such as the black color image can be applied to the data lines coupled to the damaged film. Thus, the possibility of occurring fire of the display device 100 can decrease.

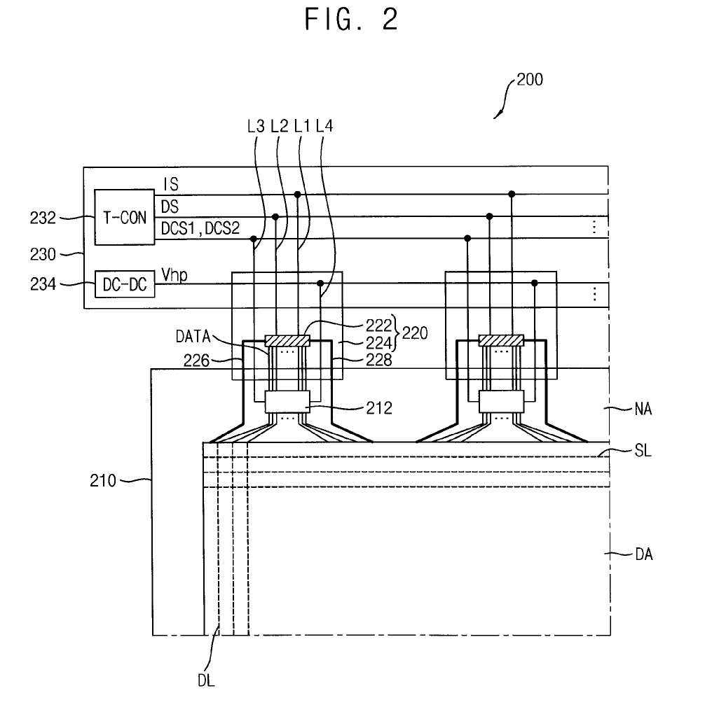

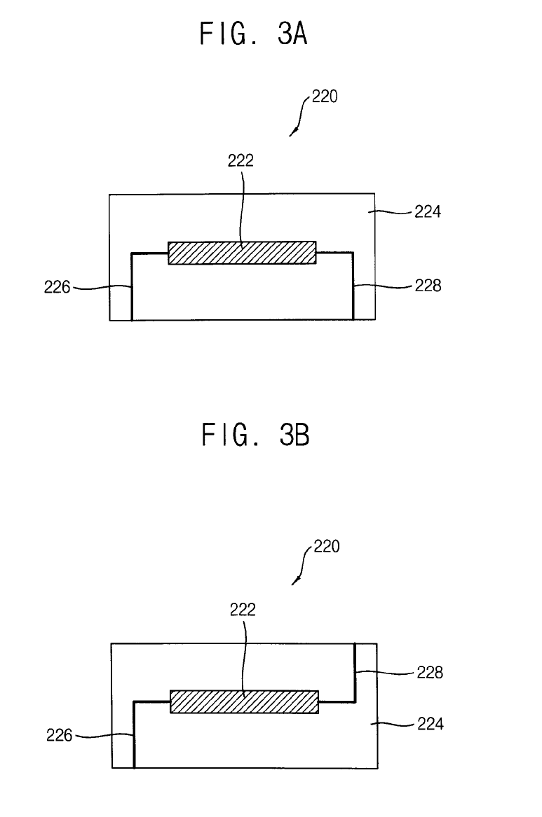

FIG. 2 is a diagram illustrating the display device of FIG. 1. FIGS. 3A and 3B are diagrams illustrating examples of a data driving unit included in the display device 100 of FIG. 1.

Referring to FIG. 2, the display device 200 can include a display panel 210, a data driving unit 220, and a data driving circuit 230. Here, the data driving unit 220 can be corresponded to the data driving unit 120 of FIG. 1.

The display panel 210 can include a display area DA and non-display area NA. A plurality of data lines DL that provide a data signal DATA or a heat prevention voltage Vhp and a plurality of scan lines SL that provide a scan signal can be formed in the display area DA. A heat prevention circuit 212 can be formed in the non-display area NA. The heat prevention circuit 212 can be coupled to an end of the data lines DL. The heat prevention circuit 212 can selectively provide the data signal DATA or the heat prevention voltage Vhp to the data lines DL based at least in part on first and second driving control signals DCS1 and DCS2 provided from a timing control unit 232 through a third line L3. When a film 224 of the data driving unit 220 is not damaged, the heat prevention circuit 212 can provide the data signal DATA to the data lines DL. Further, when a film 224 of the data driving unit 220 is damaged, the heat prevention circuit 212 can provide the heat prevention voltage Vhp to the data lines DL. Here, the heat prevention voltage Vhp can have a voltage level that displays a black color image on the display panel 210. The heat prevention circuit 212 can respectively be coupled to the data lines DL.

The data driving unit 220 can include a data driving integrated circuit 222 that converts an image signal IS output from the timing control unit 232 into the data signal DATA and the film 224 on which the data driving integrated circuit 222 is mounted. The data driving integrated circuit 222 can convert the image signal IS provided from the timing control unit 232 through a first line L1 into an analog voltage that corresponds to a grayscale value and provide the analog voltage to the data lines DL as the data signal DATA. One end of the film 224 on which the data driving integrated circuit 222 is mounted can be coupled to the display panel 210 and another end of the film 224 on which the data driving integrated circuit 222 is mounted can be coupled to the driving circuit 230. A plurality of input/output lines can be formed on the film 224. The input/output lines can electrically couple the display panel 210 to the data driving integrated circuit 222 or driving circuit 230 to the data driving integrated circuit 222. First and second sensing lines 226 and 228 that sense whether the film 224 is damaged can be formed on the film 224. The data driving integrated circuit 222 can generate a detecting signal DS indicating whether the film 224 is damaged based at least in part on a sensing signal provided from the first sensing line 226 or the second sensing line 228 and provide the detecting signal DS to the timing control unit 232 through a second line L2. For example, when the sensing signal is higher than or lower than a predetermined threshold value, the data driving integrated circuit 222 determines that the film 224 is damaged and outputs a logic low level voltage as the detecting signal DS. Further, when the sensing signal is within the predetermined threshold value, the data driving integrated circuit 222 can determine that the film 224 is not damaged and output a logic high level voltage as the detecting signal DS.

Referring to FIG. 3A, one ends of the first and second sensing lines 226 and 228 are coupled to the display panel 210 and another ends of the first and second sensing lines 226 and 228 are coupled to the data driving integrated circuit 222. The data driving integrated circuit 222 can receive the sensing signal through the first and second sensing lines 226 and 228. The sensing signal can be a voltage applied from the display panel 210 and can have a predetermined level. For example, the first and second sensing lines 226 and 228 are coupled to an initial line that provides an initial voltage to pixels of the display panel 210 and provide the sensing voltage that has substantially the same level with the initial voltage. The data driving integrated circuit 222 can generate the detecting signal DS based at least in part on the sensing signal provided through the first and second sensing lines 226 and 228. The detecting signal DS generated in the data driving integrated circuit 222 can be provided to the timing control unit 232 through the second line L2 that is formed on the film 224.

Referring to FIG. 3B, one end of the first sensing line 226 is coupled to the display panel 210 and another end of the first sensing line 226 is coupled to the data driving integrated circuit 222. Further, one end of the second sensing line 228 can be coupled to the data driving integrated circuit 222 and another end of the second sensing line 228 can be coupled to the timing control unit 232. The data driving integrated circuit 222 can receive the sensing signal through the first sensing line 226. The sensing signal can be a voltage applied from the display panel 210 and can have a predetermined level. For example, the first sensing line 226 is be coupled to an initial line that provides an initial voltage to pixels of the display panel 210 and provides the sensing voltage that has substantially the same level with the initial voltage. In some embodiments, the data driving integrated circuit 222 generates the detecting signal DS based at least in part on the sensing signal provided through the first sensing line 226. The detecting signal DS generated in the data driving integrated circuit 222 can be provided to the timing control unit 232 through the second sensing line 228 that is formed on the film 224. In some embodiments, the data driving integrated circuit 222 bypasses the sensing signal that is provided through the first sensing line 226 to the second sensing line 228. In this case, the detecting signal DS that is the same as the sensing signal of the first sensing line 226 can be provided to the timing control unit 232 through the second sensing line 228. Here, the second sensing line 228 can correspond to the second line L2.

The driving circuit 230 can include the timing control unit 232 and a DC-DC converter 234. The timing control unit 232 and a DC-DC converter 234 can be implemented with an integrated circuit and can be mounted on the printed circuit board (PCB). The timing control unit 232 can provide the image signal IS to the data driving control unit 220 through the first line L1. Further, the timing control unit 232 can provide control signals that control the data driving unit 232 and a scan driving unit to the data driving unit 232 and a scan driving unit. The timing control unit 232 can generate the first and second driving control signals DCS1 and DCS2 that control an operation of the heat prevention circuit 212 based at least in part on the detecting signal DS indicating whether the film is damaged provided from the data driving unit 220 through the second line L2. The first and second driving control signals DCS1 and DCS2 can be provided to the heat prevention circuit 212 through the third line L3. When the detecting signal DS that indicates the film is not damaged is provided to the timing control unit 232, the timing control unit 232 can provide the first and second driving control signals DCS1 and DCS2 that operate the heat prevention circuit 212 to output the data signal DATA. Further, when the detecting signal DS that indicates the film is damaged is provided to the timing control unit 232, the timing control unit 232 can provide the first and second driving control signals DCS1 and DCS2 that operate the heat prevention circuit 212 to output the heat prevention voltage Vhp. The DC-DC converter 234 can provide the heat prevention voltage Vhp to the heat prevention circuit 212 through a fourth line L4. When the heat prevention voltage Vhp is provided to the data lines DL through the heat prevention circuit 212, a black color image can be displayed on the region of the display panel where the data lines DL that receive the heat prevention voltage Vhp are formed. The heat prevention voltage Vhp can have the voltage level that displays the black color image on the display panel 210. Although the heat prevention voltage Vhp is provided from the DC-DC converter 234 in FIG. 2, the heat prevention voltage Vhp can be provided from the timing control unit 232.

As described above, the display device 200 according to example embodiments can form sensing lines 226 and 228 on the film 224 of the data driving unit 220 and sense the damage of the film 224. The data driving integrated circuit 222 can generate the detecting signal DS based at least in part on the sensing signal sensed through the sensing lines 226 and 228 and provide the detecting signal DS to the timing control unit 232. The timing control unit 232 can provide the driving control signals DCS1 and DCS2 that control the operation of the heat prevention circuit 212 to the heat prevention circuit 212 based at least in part on the detecting signal DS. The heat prevention circuit 212 can selectively provide the data signal DATA or the heat prevention voltage Vhp to the data lines DL based at least in part on the driving control signals DCS1 and DCS 2. When the film 224 of the data driving unit 220 is damaged, the heat prevention circuit 212 can provide the heat prevention voltage Vhp to the data lines DS of the display panel 210. Here, the heat prevention voltage Vhp can be the voltage that displays the black color image on the display panel 210. As described, when the film 224 of the data driving unit 220 is damaged, the data driving unit 220 can provide the heat prevention voltage Vhp that can display the image driven with a current having a relatively low level such as the black color image can be applied to the data lines coupled to the damaged film 224. Thus, the possibility of fire occurring in the display device 200 can decrease.

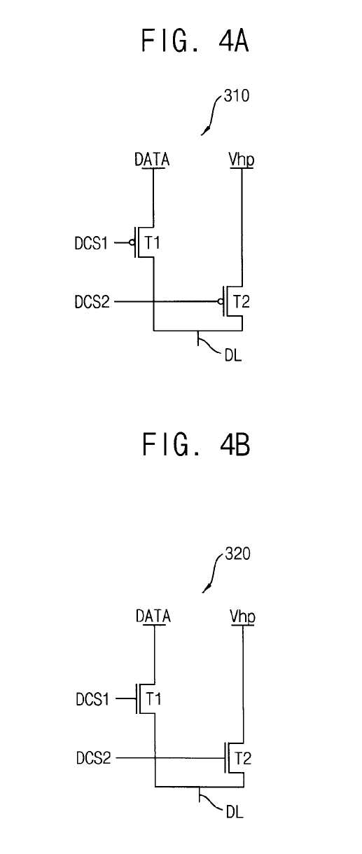

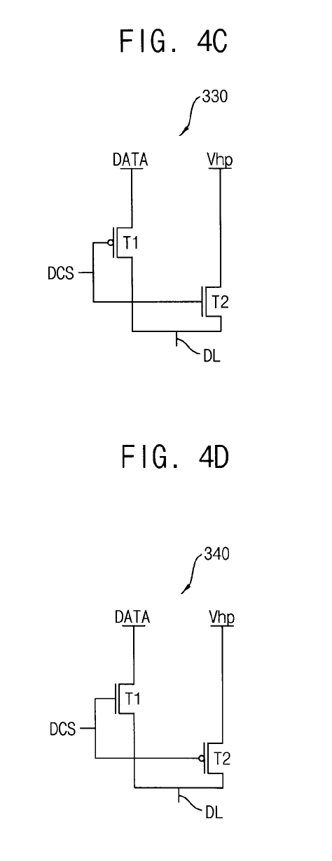

FIGS. 4A through 4D are circuit diagrams illustrating a heat prevention circuit included in the display device 100 of FIG. 1.

Referring to FIG. 4A, the heat prevention circuit 310 includes first and second switching transistors T1 and T2. As illustrated in FIG. 4A, the first and second transistors T1 and T2 are implemented as p-channel metal oxide semiconductor (PMOS) transistors. The first and second transistors T1 and T2 are turned on when a signal having a logic low level is applied to a gate electrode. The first switching transistor T1 can be turned on and the data signal DATA can be provided to the data line DL through the first switching transistor T1 when the first driving control signal DCS1 having the logic low level is applied. Further, the second switching transistor T2 can be turned on and the heat prevention voltage Vhp can be provided to the data line DL through the second switching transistor T2 when the second driving control signal DCS2 having the logic low level is applied. When the film of the data driving unit is not damaged, the first driving control signal DCS1 having the logic low level can be provided to the first switching transistor T1, the second driving control signal DCS2 having a logic high level can be provided to the second switching transistor T2, and the data signal DATA can be provided to the data line DL. When the film of the data driving unit is damaged, the first driving control signal DCS1 having the logic high level can be provided to the first switching transistor T1, the second driving control signal DCS2 having the logic low level can be provided to the second switching transistor T2, and the heat prevention voltage Vhp can be provided to the data lines DL.

Referring to FIG. 4B, the heat prevention circuit 320 includes first and second switching transistors T1 and T2. As illustrated in FIG. 4B, the first and second transistors T1 and T2 can be implemented as n-channel metal oxide semiconductor (NMOS) transistors. The first and second transistors T1 and T2 are turned on when a signal having a logic high level is applied to a gate electrode. The first switching transistor T1 can be turned on and the data signal DATA can be provided to the data line DL through the first switching transistor T1 when the first driving control signal DCS1 having the logic high level is applied. Further, the second switching transistor T2 can be turned on and the heat prevention voltage Vhp can be provided to the data line DL through the second switching transistor T2 when the second driving control signal DCS2 having the logic high level is applied. When the film of the data driving unit is not damaged, the first driving control signal DCS1 having the logic high level can be provided to the first switching transistor T1, the second driving control signal DCS2 having a logic low level can be provided to the second switching transistor T2, and the data signal DATA can be provided to the data line DL. When the film of the data driving unit is damaged, the first driving control signal DCS1 having the logic low level can be provided to the first switching transistor T1, the second driving control signal DCS2 having the logic high level can be provided to the second switching transistor T2, and the heat prevention voltage Vhp can be provided to the data lines DL.

Referring to FIG. 4C, the heat prevention circuit 330 includes first and second switching transistors T1 and T2. As illustrated in FIG. 4C, the first switching transistor T1 is implemented as a PMOS transistor and the second switching transistor T2 is implemented as an NMOS transistor. The first transistor T1 is turned on when a signal having a logic low level is applied to a gate electrode. The second transistor T2 is turned on when a signal having a logic high level is applied to a gate electrode. The first switching transistor T1 can be turned on and the data signal DATA can be provided to the data line DL through the first switching transistor T1 when the driving control signal DCS having the logic low level is applied. Further, the second switching transistor T2 can be turned on and the heat prevention voltage Vhp can be provided to the data line DL through the second switching transistor T2 when the driving control signal DCS having the logic high level is applied. When the film of the data driving unit is not damaged, the driving control signal DCS having the logic low level can be provided to the first switching transistor T1 and the second switching transistor T2 and the data signal DATA can be provided to the data line DL. When the film of the data driving unit is damaged, the driving control signal DCS having the logic high level can be provided to the first and second switching transistors T1 and T2 and the heat prevention voltage Vhp can be provided to the data line DL.

Referring to FIG. 4D, the heat prevention circuit 340 includes first and second switching transistors T1 and T2. As illustrated in FIG. 4D, the first switching transistor T1 is implemented as an NMOS transistor and the second switching transistor T2 is implemented as a PMOS transistor. The first transistor T1 is turned on when a signal having a logic high level is applied to a gate electrode. The second transistor T2 is turned on when a signal having a logic low level is applied to a gate electrode. The first switching transistor T1 can be turned on and the data signal DATA can be provided to the data line DL through the first switching transistor T1 when the driving control signal DCS having the logic high level is applied. Further, the second switching transistor T2 can be turned on and the heat prevention voltage Vhp can be provided to the data line DL through the second switching transistor T2 when the driving control signal DCS having the logic low level is applied. When the film of the data driving unit is not damaged, the driving control signal DCS having the logic high level can be provided to the first switching transistor T1 and the second switching transistor T2 and the data signal DATA can be provided to the data line DL. When the film of the data driving unit is damaged, the driving control signal DCS having the logic low level can be provided to the first switching transistor T1 and the second switching transistor T2 and the heat prevention voltage Vhp can be provided to the data line DL.

As described above, the heat prevention circuits 310 through 340 can selectively provide the data signal DATA or the heat prevention voltage Vhp to the data line DL based at least in part on the driving control signals DCS1, DCS2, and DCS. Although the heat prevention circuits 310 through 340 that include the PMOS transistor and the NMOS transistor are illustrated in FIGS. 4A through 4D, the heat prevention circuit is not limited thereto.

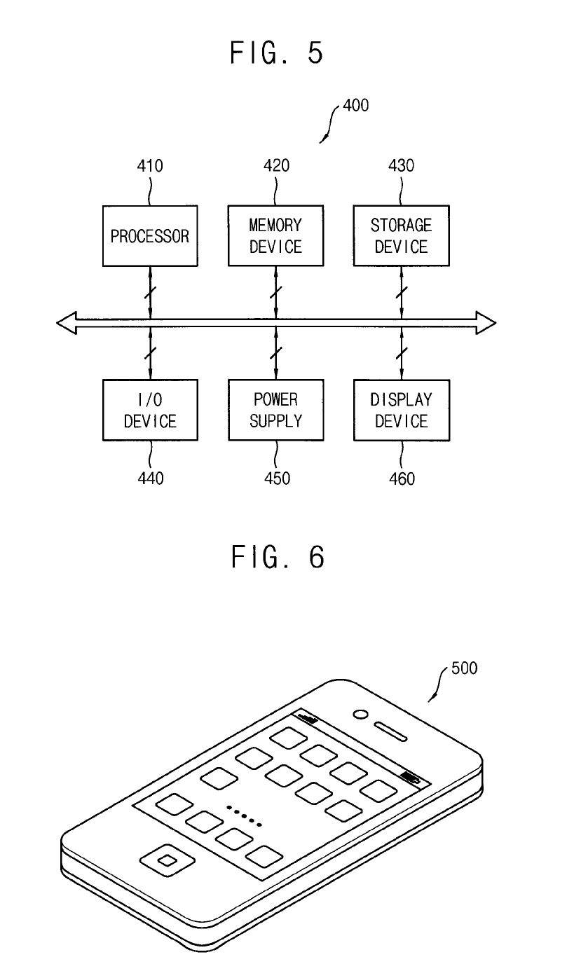

FIG. 5 is a block diagram illustrating an electronic device having the display device 100 of FIG. 1. FIG. 6 is a diagram illustrating an example in which the electronic device of FIG. 5 is implemented as a smartphone.

Referring to FIGS. 5 and 6, an electronic device 400 includes a processor 410, a memory device 420, a storage device 430, an input/output (I/O) device 440, a power supply 450, and a display device 460. Here, the display device 460 can correspond to the display device 100 of FIG. 1. In addition, the electronic device 400 can further include a plurality of ports for communicating with a video card, a sound card, a memory card, a universal serial bus (USB) device, other electronic device, etc. Although it is illustrated in FIG. 6 that the electronic device 400 is implemented as a smartphone 500, the electronic device 400 is not limited thereto.

The processor 410 can perform various computing functions. The processor 410 can be a microprocessor, a central processing unit (CPU), etc. The processor 410 can be coupled to other components via an address bus, a control bus, a data bus, etc. Further, the processor 410 can be coupled to an extended bus such as peripheral component interconnect (PCI) bus. The memory device 420 can store data for operations of the electronic device 600. For example, the memory device 420 includes at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 430 can be a solid state drive (SSD) device, a hard disk drive (HDD) device, a CD-ROM device, etc.

The I/O device 440 can be an input device such as a keyboard, a keypad, a touchpad, a touch-screen, a mouse, etc., or an output device such as a printer, a speaker, etc. In some embodiments, the display device 460 is included in the I/O device 440. The power supply 450 can provide power for operations of the electronic device 400. The display device 460 can communicate with other components via the buses or other communication links. As described, the display device 460 can include the display panel 110 or 210, the data driving unit 120 or 220, the scan driving unit 130, and the timing control unit 140 or 232.

As described above, the electronic device 400 according to example embodiments can prevent heat from occurring due to the damaged film on which the data driving integrated circuit is mounted by including the display device 460 that detects the damage of the film and selectively provides the data signal or the heat prevention voltage to the data line based at least in part on the damage of the film. For example, when the film is not damaged, the heat prevention circuit of the display device 460 provides the data signal to the data lines. Further, when the film is damaged, the heat prevention circuit of the display device 460 can provide the heat prevention voltage to the data lines. Here, the heat prevention voltage can have the voltage level that displays a black color image on the display panel. As described, when the film of the data driving unit is damaged, the display device 460 can provide the heat prevention voltage that can display an image driven with a current having relatively low level such as the black color image. Thus, the possibility of fire occurring in the display device 400 can decrease.

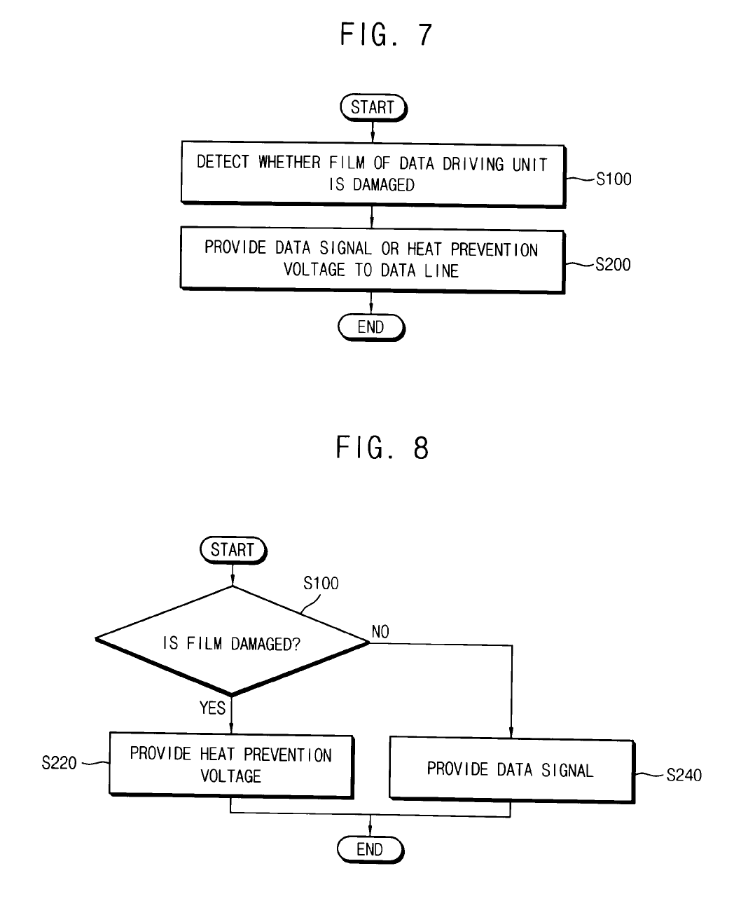

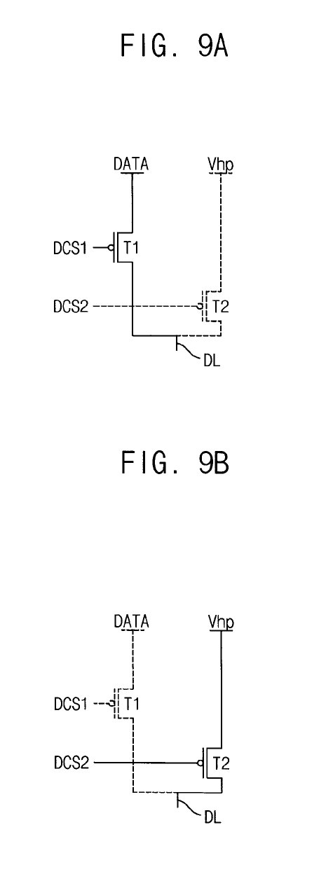

FIG. 7 is a flowchart illustrating a method of driving a display device according to example embodiments. FIG. 8 is a flowchart illustrating a method of providing data signal or heat prevention voltage by the method of FIG. 7. FIGS. 9A and 9B are diagrams illustrating examples of an operating of a heat prevention circuit by the method of FIG. 7.

In some embodiments, the FIG. 7 procedure is implemented in a conventional programming language, such as C or C++ or another suitable programming language. The program can be stored on a computer accessible storage medium of the display device 100, for example, a memory (not shown) of the display device 100 or timing controller 140. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 7. The description of this paragraph applies to the embodiment shown in FIG. 8.

Referring to FIGS. 7 and 8, a method of driving a display device of FIG. 7 includes detecting whether a film of a data driving unit is damaged (S100). The method also includes selectively providing a data signal or a heat prevention voltage to a data line of a display panel based at least in part on whether the film is damaged (S200).

In S100, the data driving unit can be implemented by a chip on film that includes a data integrated circuit that converts an image signal output from a timing control unit into the data signal and the film on which the data driving integrated circuit is mounted. First and second sensing lines can be formed on the film of the data driving unit to sense whether the film is damaged. In some embodiments, one ends of the first and second sensing lines are coupled to the display panel and another ends of the first and second sensing lines are coupled to the data driving integrated circuit. The data driving integrated circuit can generate the detecting signal indicating whether the film is damaged based at least in part on a sensing signal provided through the first and second sensing lines. Here, the sensing signal can be a voltage applied from the display panel and can have a predetermined level. In some embodiments, one end of the first sensing line is coupled to the display panel and another end of the first sensing line is coupled to the data driving integrated circuit. Further, one end of the second sensing line can be coupled to the data integrated circuit and another end of the second sensing line can be coupled to the timing control unit. The data driving control integrated circuit can generate the detecting signal by receiving the sensing signal through the first sensing line and output the detecting signal to the timing control unit through the second sensing line. Here, the sensing signal can be a voltage applied from the display panel and can have a predetermined level.

The timing control unit can generate first and second driving control signals that controls an operation of the heat prevention circuit based at least in part on the detecting signal provided from the data driving unit. For example, when the detecting signal indicates the film is not damaged and is provided to the timing control unit, the timing control unit provides the first and second driving control signals that operate the heat prevention circuit to output the data signal. Further, when the detecting signal indicates the film is damaged and is provided to the timing control unit, the timing control unit can provide the first and second driving control signals that operate the heat prevention circuit to output the heat prevention voltage.

In S200, the heat prevention circuit can selectively provide the data signal or the heat prevention voltage to the data line based at least in part on the first and second driving control signal provided from the timing control unit. Here, the heat prevention voltage can have a voltage level that displays a black color image on the display panel.

Referring to FIG. 8, when the film of the data driving unit is not damaged, the heat prevention circuit provides the data signal to the data lines of the display panel (S220). Referring to FIG. 9A, the heat prevention circuit includes a first switching transistor T1 and a second switching transistor T2. The first and second switching transistors T1 and T2 can be implemented as PMOS transistors. When the film is not damaged, the timing control unit can provide the first driving control signal DCS1 having a logic low level and the second driving control signal DCS2 having a logic high level to the heat prevention circuit. The data signal DATA can be provided to the data line DL by turning on the first switching transistor T1 based at least in part on the first driving control signal DCS1 and turning off the second switching transistor T2 based at least in part on the second driving control signal DCS2.

Referring to FIG. 8, when the film of the data driving unit is damaged, the heat prevention circuit provides the heat prevention voltage to the data lines of the display panel (S240). Referring to FIG. 9B, the heat prevention circuit includes a first switching transistor T1 and a second switching transistor T2. The first and second switching transistors T1 and T2 can be implemented as PMOS transistor. When the film is damaged, the timing control unit can provide the first driving control signal DCS1 having a logic high level and the second driving control signal DCS2 having a logic low level to the heat prevention circuit. The heat prevention voltage Vhp can be provided to the data line DL by turning off the first switching transistor T1 based at least in part on the first driving control signal DCS1 and by turning on the second switching transistor T2 based at least in part on the second driving control signal DCS2.

Although the heat prevention circuit that is implemented as PMOS transistors is described in FIGS. 9A and 9B, the heat prevention circuit is not limited thereto. In some embodiments, the heat prevention circuit is implemented as NMOS transistors. Further, the heat prevention circuit can be implemented with both PMOS transistors and NMOS transistors.

Thus, when the film of the data driving unit is damaged, the heat prevention voltage that can display an image driven with a current having relatively low level such as the black color image can be applied to the data lines coupled to the damaged film. Thus, the possibility of occurring fire of the display device can decrease.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive concept. Accordingly, all such modifications are intended to be included within the scope of the inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel including a plurality of pixels formed in a display area and a heat prevention circuit formed in a non-display area, wherein the heat prevention circuit is configured to selectively provide a data signal or a heat prevention voltage to a plurality of data lines;
a data driver electrically connected to the data lines and configured to provide the data signal or the heat prevention voltage to the display panel;
a scan driver configured to provide a scan signal to the display panel through a plurality of scan lines; and
a timing controller configured to control the heat prevention circuit, the data driver, and the scan driver.

2. The display device of claim 1, wherein the data driver is formed as a chip on film (COF) including i) a data driving integrated circuit (IC) configured to convert an image signal output from the timing controller into the data signal and ii) a film on which the data driving IC is mounted.

3. The display device of claim 2, further comprising first and second sensing lines formed over the film and configured to sense whether the film is damaged.

4. The display device of claim 3, wherein first ends of the first and second sensing lines are electrically connected to the display panel, and wherein second ends of the first and second sensing lines are electrically connected to the data driving IC.

5. The display device of claim 4, wherein the data driving IC is further configured to i) generate a detecting signal indicating whether the film is damaged based at least in part on a sensing signal provided from the first and second sensing lines and ii) provide the detecting signal to the timing controller.

6. The display device of claim 3, wherein a first end of the first sensing line is electrically connected to the display panel, wherein a second end of the first sensing line is electrically connected to the data driving integrated circuit, wherein a first end of the second sensing line is electrically connected to the data driving IC, and wherein a second end of the second sensing line is electrically connected to the timing controller.

7. The display device of claim 6, wherein the data driving IC is further configured to i) generate a detecting signal indicating whether the film is damaged based at least in part on a sensing signal provided from the first sensing line and ii) provide the detecting signal to the timing controller through the second sensing line.

8. The display device of claim 2, wherein the timing controller is further configured to generate first and second driving control signals configured to control the heat prevention circuit based at least in part on a detecting signal indicating whether the film is damaged, wherein the first driving control signal indicates that the film is not damaged, and wherein the second driving control signal indicates that the film is damaged.

9. The display device of claim 8, wherein the heat prevention circuit includes:
a first switching transistor configured to output the data signal based at least in part on the first driving control signal; and
a second switching transistor configured to output the heat prevention voltage to the data lines based at least in part on the second driving control signal.

10. The display device of claim 9, wherein each of the first and second transistors includes a p-channel metal oxide semiconductor (PMOS) transistor.

11. The display device of claim 10, wherein, when the film is damaged, the first driving control signal has a logic high level and the second driving control signal has a logic low level.

12. The display device of claim 10, wherein, when the film is not damaged, the first driving control signal has a logic low level, and the second driving control signal has a logic high level.

13. The display device of claim 9, wherein each of the first and second transistors includes a n-channel metal oxide semiconductor (NMOS) transistor.

14. The display device of claim 13, wherein, when the film is damaged, the first driving control signal has a logic low level and the second driving control signal has a logic high level.

15. The display device of claim 13, wherein, when the film is not damaged, the first driving control signal has a logic high level and the second driving control signal has a logic low level.

16. The display device of claim 1, wherein the display panel is configured to display a black color image on a region where the data lines are formed when the heat prevention voltage is provided to the data lines.

17. A method of driving a display device, the method comprising:
detecting whether a film of a data driver is damaged, wherein the data driver is formed as a chip on film (COF) including a data driving integrated circuit (IC) and a film on which the data driving IC is mounted; and
selectively providing a data signal or a heat prevention voltage to a data line of a display panel based at least in part on whether the film is damaged.

18. The method of claim 17, wherein the selectively providing includes:
providing the data signal to the data line when the film is not damaged; and
providing the heat prevention voltage to the data line when the film is damaged.

19. The method of claim 17, further comprising:
forming first and second sensing lines configured to sense whether the film is damaged over the film; and
generating a detecting signal indicating whether the film is damaged based at least in part on the sensing signal received from the first and second sensing lines.

20. The method of claim 17, further comprising displaying a black color image on a region of the display panel where the data lines are formed when the heat prevention voltage is provided to the data lines.
